(19) United States
(12) Patent Application Publication
(10) Pub. No.: US 2025/0119401 A1
(43) Pub. Date: Apr. 10, 2025

(54) COMMUNICATION SYSTEM AND METHOD USING UNIQUE IDENTIFIERS

(71) Applicant: Events.com, Inc., San Diego, CA (US)

(72) Inventor: Andrew Michael PHIPPS, La Jolla, CA (US)

(73) Assignee: Events.com, Inc., San Diego, CA (US)

(21) Appl. No.: 18/658,812

(22) Filed: May 8, 2024

Related U.S. Application Data
(63) Continuation of application No. 18/158,382, filed on Jan. 23, 2023, now abandoned.
Application No. 18/158,382 is a continuation of application No. 16/795,487, filed on Feb. 19, 2020, now abandoned.
Application No. 16/795,487 is a continuation of application No. 15/132,160, filed on Apr. 18, 2016, now abandoned.
Application No. 15/132,160 is a continuation of application No. 12/784,421, filed on May 20, 2010, now abandoned.
Application No. 12/784,421 is a continuation of application No. 11/359,118, filed on Feb. 21, 2006, now abandoned.
(60) Provisional application No. 60/656,015, filed on Feb. 23, 2005.
(60) Provisional application No. 60/655,494, filed on Feb. 22, 2005.

(51) Int. Cl. H04L 51/48; G06Q 10/00; G06Q 50/26; H04L 51/04; H04L 101/37; H04L 101/69

(52) U.S. Cl. CPC H04L 51/48; G06Q 10/00; G06Q 50/26; H04L 51/04; H04L 2101/37; H04L 2101/69

(57) ABSTRACT

A communication system in which a plurality of unique identifiers (license plates) from certain defined classes of unique identifiers (i.e. license plates) are converted into electronic addresses enabling digital communication, content, and commerce to be transferred to the associated address. A verified rightful holder of the unique identifier can claim rights which can grant access to the digital data that has been transferred to the assigned electronic address. A sender, without knowing the identity of the holder of the unique identifier, may communicate a message to the converted corresponding electronic address in the hopes that the holder will claim the email address through a verification process. A central domain repository may be used to determine and publish a uniform convention for the unique identifier, to establish a standard that is universal.

### CROSS REFERENCE TO RELATED APPLICATIONS

This application is a continuation of U.S. application Ser. No. 18/158,382, filed Jan. 23, 2023, which is a continuation of U.S. application Ser. No. 16/795,487, filed Feb. 19, 2020, which is a continuation of Ser. No. 15/132,160, filed on Apr. 18, 2016, which is a continuation of U.S. patent application Ser. No. 12/784,421, filed on May 20, 2010, which is a continuation of U.S. patent application Ser. No. 11/359,118, filed on Feb. 21, 2006, which claims the benefit of priority to U.S. Provisional Application No. 60/655,494, filed Feb. 22, 2005 and to U.S. Provisional Application No. 60/656,015, filed Feb. 23, 2005, entitled “Unique Identifier Messaging,” the disclosures of each of which are incorporated herein by reference in their entirety.

### FIELD OF INVENTION

The present invention generally relates to a method and system of converting a unique identifier (i.e. legally valid alphanumeric license plate number) into an associated or corresponding email address, according to a published convention contained at a central domain repository (i.e. website) enabling online transfer of digital data, including but not limited to transfer of digital communication, content, and commerce; to the assigned electronic address for the unique identifier (i.e. license plate number). The present invention includes the field of unique identifier messaging, such as license-plate based messaging to virtually anyone, anything, anytime, anywhere.

### BACKGROUND OF THE INVENTION

Prior art in this field has focused on the need for a person to access a central database (i.e. Department of Motor Vehicles), in order to communicate with another based on a unique identifier (i.e. license plate) of a defined class of identifiers (i.e. license plates, social security numbers, telephone numbers), as well as to determine the identity of the rightful holder of a unique identifier (i.e. license plate), obtaining from the database the holders personal information, including address, in order for one person or entity to communicate, deliver content, or conduct commerce with the holder of the unique identifier (i.e. license plate). Restrictions are placed on access to this central database to protect the privacy of the holder or the unique identifier (i.e. protect identity of holder of a license plate). An obvious concept to enable communication between parties based on identifiers, such as license plates, was to host a database on the web and provide access to the database to obtain contact information for another based on their identifier, or even more obvious to allow the person to send a message to a website acting as a clearinghouse, and then this clearinghouse proposed to forward the message on to an email address for the person associated with the license plate. The problem with the aforementioned approach was that its success would depend on the ability to attract the mass scale of license placeholders that exist to sign up and provide their contact information; the ability for this approach to succeed commercially was nil.

### SUMMARY OF THE INVENTION

Disclosed herein is a communication system and method in which a unique identifier (i.e. legally valid alphanumeric license plate) is converted into a corresponding electronic address (i.e. email address) by means of referencing a central domain repositories (i.e. server) website for the published uniform convention of a definitive class of unique identifiers (i.e. legally valid alphanumeric license plates), enabling anyone, anywhere, anytime to transfer digital data, including but not limited to communication, content, and commerce to a unique identifier(s) corresponding electronic address, such as but not limited to, an email address.

In accordance with this invention, the unique identifier(s) corresponding electronic address is hosted at a central domain repository (i.e. mail server), incoming digital communication, content and commerce, would be forwarded to a mail client if one exists for the email, or a catch-all address for the domain name of the central domain repository used in the convention of the communication would receive and store the digital data for access by site administration. Senders of digital data can include variables in the sending of any digital communication, such as including but not limited to, a subject line in an email that deems the communication “public” or “private”. A listing of variables and there corresponding value can be published at a website provided by the central domain repository. For example, a digital communication sent to a license plate number's corresponding address could include a subject line that contains the word “public”, which would indicate to the central domain repository that the sender would like the site administrator to post the contents to its website in order for the communication or content to be viewable by the public and hopefully the rightful holder of the license plate number. Alternatively, in accordance with the invention, a subject line that contains the word “private”, which would indicate to the central domain repository that the sender would like the site administrator to store the digital communication, content and commerce, for later retrieval by someone who claims and is verified by the central domain repository as the rightful holder of the license plate.

It is an object of some aspects of the invention to facilitate communication between senders and receivers of digital data to the unique identifiers corresponding address, including but not limited to transmission of communication, content, and commerce via the central domain repository.

In preferred embodiments of the present invention, a domain name at a specific URL hosts a website where a uniform convention for conversion of a legally valid alphanumeric license plate number to an email address are published. A conversion for a license plate number, as a defined class of unique identifiers, could have the following convention:
License Plate Conversion to Email Address Convention
Using a string sequence as in a standard email format
Element 1: string sequence is the alphanumeric license plate number
Element 2: string sequence is a period or dot (used to define parameters of plate number)
Element 3: string sequence is a US postal code or country postal code abbreviation
Element 4: string sequence is an @symbol
Element 5: string sequence is the assigned domain name for the central domain repository
Element 6: string sequence is a period or dot (used to separate domain name and top-level domain name.
Element 7: string sequence is the assigned top-level domain for the central domain repository.

Using the preceding convention it would enable a person utilizing this method anywhere, anytime; who so wanted or needed to contact virtually anyone, to view any legally valid license plate and instantly know that a digital communication could be sent to an email address already existing residing on a mail server at a central domain repository which corresponds and associates with that license plate, and furthermore, in accordance with this invention, where a rightful holder (i.e. driver of the car containing the license plate) could receive that communication by contracting with the central domain repository for access to the communication. A central domain repository can have a mail server residing at a domain name, such as Platestate.com, in accordance with this invention. A person views a license plate on a car on a freeway; the license plate contains the alphanumeric characters “USA111” and indicates the issuing state as California; the person using the conversion herein contained would know to address the license plate at USA111.CA@PLATESTATE.COM. A driver of a car who is the rightful holder of that license plate can then visit the central domain repository, in this example PLATESTATE.COM and then do a search or contact the site administrator to determine if his or her license plate has received any digital communication, content, and/or commerce. If there is a communication that the mail server hosted by platestate.com has received, then this communication can be posted to the website for public viewing, or the rightful holder can contract and be verified with the central domain repository for access privately to the digital communication, content, or commerce via claiming through registration procedures the assigned email address and being provided a mail client with secure password access to the email, or having emails sent to the license plates corresponding email address forwarded to another email address provided by the verified and contracted rightful holder of the license plate.

In accordance with the invention, no prior registration by a rightful holder of a unique identifier is necessary at the central domain repository, since the digital communication is addressed to the object itself, the unique identifier, rather than the person who is the rightful holder of the object.

In accordance with the invention, the central domain repository acts as a gateway for the transfer of all digital data. Data transmitted via the gateway is stored on a server assigned for such purpose, and handled according to site administrator rules, and transmitted at a later time according to this invention and established rules by the site administrator.

In accordance with this invention, a verification method for determining the identity of the actual rightful holder of the license plate or other unique identifier, consisting of publishing an accessible verification policy and procedure instructions at the central domain repository, requesting supporting documentation, including but not limited to an affidavit, a signed release of personal information from a state DMV, a copy of a car registration, a drivers license, and/or a credit card number; requesting a fax, email or any other acceptable delivery method, of said supporting documents to the central domain repository. Information provided is then validated by making a request to a state agency to validate the authenticity of the claimed rightful holder to the unique identifier.

In accordance with this invention, digital content can be sent to a unique identifiers converted corresponding email address. A driver of one car can take a picture of him self, and send the picture to the converted email address of a license plate in hopes that the driver of the car with the license plate makes access with the website of the central domain repository.

In accordance with this invention, monetary transactions can be sent to a unique identifiers converted corresponding email address. A person, without knowing the actual identity of the rightful holder of a unique identifier, such as a license plate, can send monies via an online payment solution, such as PayPal®, to the converted email address of a unique identifier of which a rightful holder of the unique identifier is later verified can receive these monies, and these monies can be a consideration for a good and/or service, a gift, or just a donation.

In accordance with this invention, a claim for a method and system for converting a unique identifier, from a defined class of unique identifiers; distinctly including but not limited to license plates, social security numbers, credit card numbers, or anything else within the scope, into a corresponding electronic address (i.e. email address) or anything else within the scope, comprising: hosting an internet accessible central domain repository, including but not limited to an internet website destination accessible via a uniform resource locater, publishing a convention of conversion for a defined class of unique identifiers, including but not limited to a legally valid alphanumeric license plate number, a legally valid social security number, a valid credit card number, or anything else within the scope; into an online accessible address, including but not limited to an email address, or anything else within the scope.

### BRIEF DESCRIPTION OF DRAWINGS

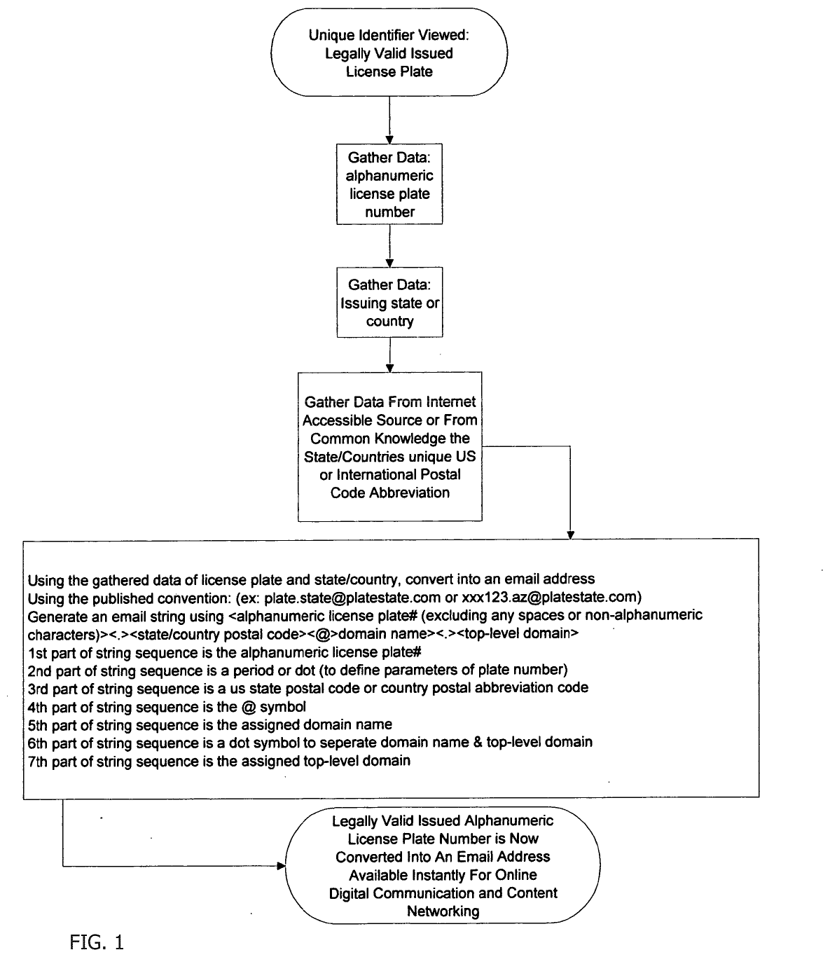

Referring to FIG. 1 is a flowchart diagram of the process in converting a unique identifier, in this example a license plate, to an email address.

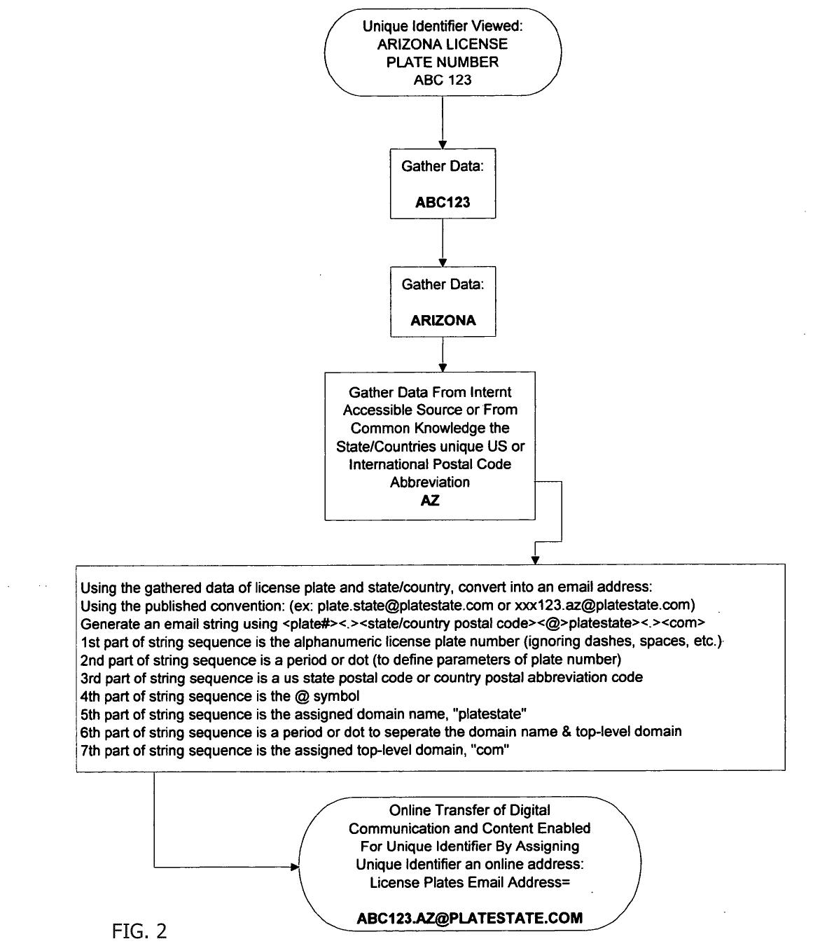

Referring to FIG. 2 is a flowchart diagram of a theoretical license plate to email address conversion.

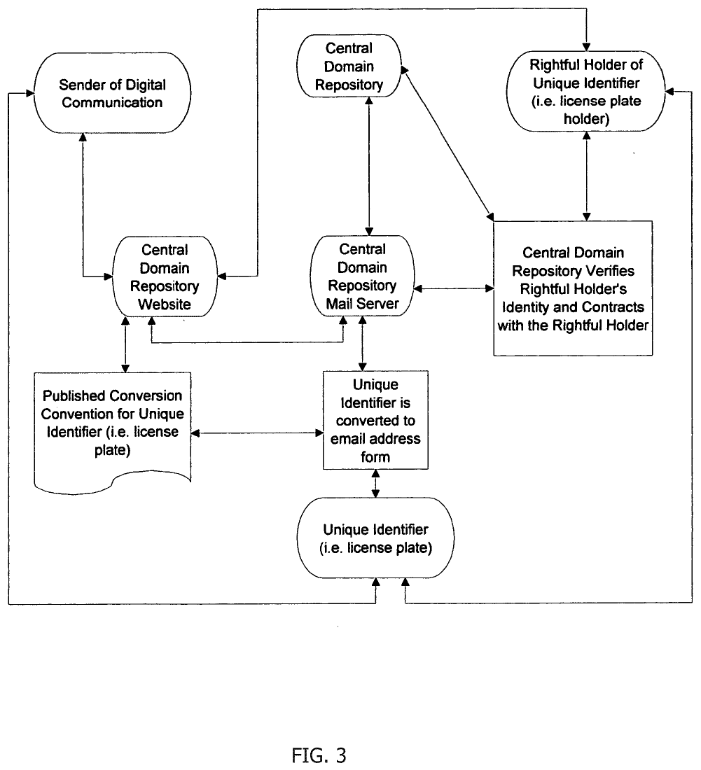

Referring to FIG. 3, in accordance with the invention, is a diagram of the relationship between the central domain repository (site administrator), central domain repository mail server, central domain repository website, the sender of a digital communication using the invention, the unique identifier, the central domain repository contract and verification process of the rightful holder of the unique identifier, the rightful holder of the unique identifier, the published conversion convention. Sender of digital communication views website, learns about the ability to send communications to license plate holders, according to the invention process and method. The sender views a license plate, converts into an email address according to the invention, and sends communication. The central domain repository receives the digital communication on a mail server assigned according to the invention and the central domain repository site administrator audits the message. A rightful holder of the license plate visits the central domain registry and views to see if any communications were sent to his or her license plate, in turn a rightful holder can contract and be verified by the central domain repository as the verified rightful holder of the license plate. The central domain repository grants access to the mail server to the rightful holder to have access to an email account corresponding for email addressed to the license plate.

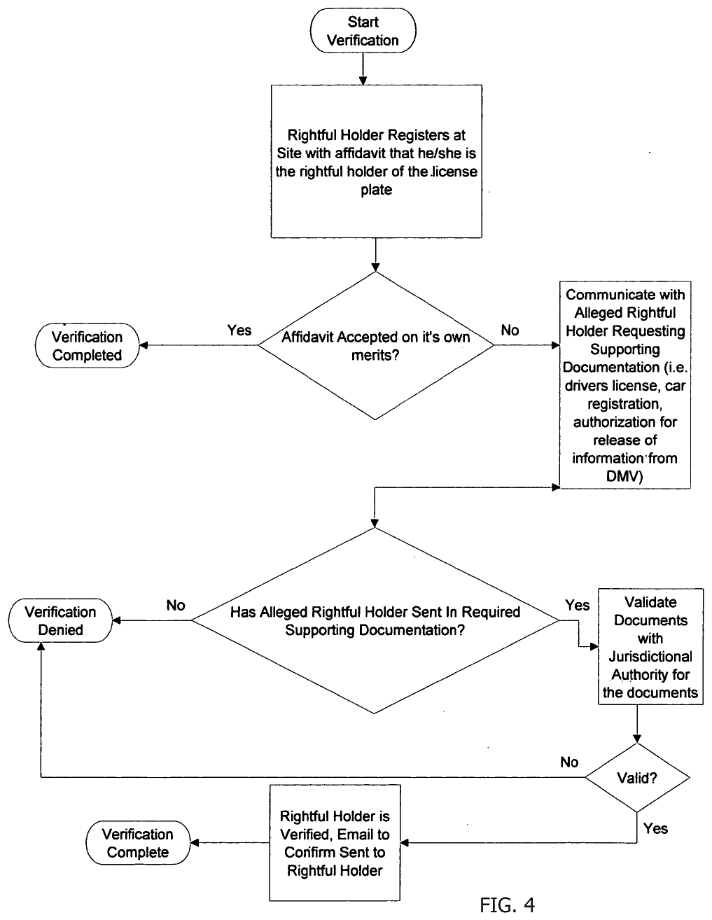

Referring to FIG. 4 is a flow chart diagram of the verification of the rightful holder of a unique identifier, according to the invention.

1. A computer-implemented method for facilitating electronic communication using unique identifiers, the method comprising:
establishing an electronic repository in which a plurality of unique identifiers are respectively associated with a corresponding plurality of electronic addresses;
receiving, at a gateway server, an electronic communication including content, the electronic communication being addressed to one of the plurality of electronic addresses wherein the one of the plurality of electronic addresses corresponds to a conversion of one identifier of the plurality of unique identifiers using a published convention of conversion viewable prior to sending of the electronic communication;
receiving, at the gateway server, a communication access request from a first user relating to the one identifier of the plurality of unique identifiers;
receiving, from the first user, an authorization for release of information from an entity that issues the unique identifiers;
verifying legitimacy of the communication access request; and
enabling, responsive to the verifying, electronic access to the content by the first user.

2. The method of claim 1 wherein the plurality of unique identifiers comprise a plurality of license plate numbers.

3. The method of claim 1 wherein the electronic communication comprises electronic mail.

4. The method of claim 1 wherein the electronic communication comprises posting information upon a website.

5. The method of claim 2 wherein the verifying legitimacy includes verifying that a sender of the communication access request is a rightful holder of a one of the plurality of license plate numbers corresponding to the one identifier.

6. The method of claim 1 further including generating at least one of the plurality of electronic addresses based upon one of the plurality of unique identifiers.

7. A computer-implemented method for facilitating electronic communication using unique identifiers, the method comprising:
establishing an electronic repository in which a plurality of unique identifiers are respectively associated with a corresponding plurality of electronic addresses;
receiving, at a gateway server, an electronic communication including content, the electronic communication being addressed to one of the plurality of electronic addresses wherein the one of the plurality of electronic addresses corresponds to a conversion of one identifier of the plurality of unique identifiers using a published convention of conversion viewable prior to sending of the electronic communication;
receiving, at the gateway server, an electronic request to communicate content to a recipient associated with the one identifier of the plurality of unique identifiers;
receiving, from the recipient, an authorization for release of information from an entity that issues the unique identifiers;
verifying legitimacy of the recipient; and
generating a message containing the content using the one of the plurality of electronic addresses associated with the one identifier.

8. The method of claim 7 wherein the plurality of unique identifiers comprise a plurality of license plate numbers.

9. The method of claim 7 wherein the electronic communication comprises electronic mail.

10. The method of claim 7 wherein the electronic communication comprises posting information upon a website.

11. The method of claim 8 wherein the verifying legitimacy includes verifying that the recipient is a rightful holder of a one of the plurality of license plate numbers corresponding to the one identifier.

12. The method of claim 7 further including generating at least one of the plurality of electronic addresses based upon one of the plurality of unique identifiers.

13. A computer program product comprising a non-transitory computer-readable medium including codes for causing a computer to:
establish an electronic repository in which a plurality of unique identifiers are respectively associated with a corresponding plurality of electronic addresses;
receive an electronic communication including content, the electronic communication being addressed to one of the plurality of electronic addresses wherein the one of the plurality of electronic addresses corresponds to a conversion of one identifier of the plurality of unique identifiers using a published convention of conversion viewable prior to sending of the electronic communication;
receive a communication access request relating to one identifier of the plurality of unique identifiers;
receive, from the first user, an authorization for release of information from an entity that issues the unique identifiers;
verify legitimacy of the communication access request; and
enable, responsive to the legitimacy verification, electronic communication using the one of the plurality of electronic addresses corresponding to the one identifier.

14. The computer program product of claim 13 wherein the plurality of unique identifiers comprise a plurality of license plate numbers.

15. The computer program product of claim 13 wherein the electronic communication comprises electronic mail.

16. The computer program product of claim 13 wherein the electronic communication comprises posting information upon a website.

17. The computer program product of claim 14 wherein the codes for causing the computer to verify legitimacy further include codes to verify that a sender of the communication access request is a rightful holder of a one of the plurality of license plate numbers corresponding to the one identifier.

18. The computer program product of claim 13 further including codes for causing the computer to generate at least one of the plurality of electronic addresses based upon one of the plurality of unique identifiers.

19. (canceled)
